(19) United States
(12) Patent Application Publication
(10) Pub. No.: US 2024/0215582 A1
(43) Pub. Date: Jul. 4, 2024

(54) METHODS OF CONTROLLING PLANT PATHOGENS

(71) Applicant: Valent BioSciences LLC, Libertyville, IL (US)

(72) Inventors: Julia Crane, Libertyville, IL (US); Nicole Higgs, Racine, WI (US); Gary T Wang, Libertyville, IL (US); Christine Kraus, Zionsville, IL (US); Sara Parker, Pleasant Prarie, WI (US); Qingyao Shou, Mason, OH (US); Francisco Romero Millan, Leon (ES); William Weldon, Chicago, IL (US); Jose Maria Sanchez Lopez, Leon (ES)

(21) Appl. No.: 18/392,247

(22) Filed: Dec. 21, 2023

Related U.S. Application Data
(60) Provisional application No. 63/434,585, filed on Dec. 22, 2022.

(51) Int. Cl. A01N 43/90; A01P 3/00

(52) U.S. Cl. CPC A01N 43/90; A01P 3/00

(57) ABSTRACT

The present invention is directed to methods of controlling oomycetes comprising applying one or more cervinomycins. The present invention is further directed to methods of controlling particular fungi comprising applying one or more cervinomycins.

### FIELD OF THE INVENTION

The present invention is directed to methods of controlling oomycetes comprising applying one or more cervinomycins. The present invention is further directed to methods of controlling particular fungi comprising applying one or more cervinomycins.

### BACKGROUND OF THE INVENTION

Plant pathogens are a major cause of severe economic loss in the agricultural and horticultural industries. Plant pathogens account for the loss of millions of pounds of crops each year. Two particularly troublesome types of plant pathogens are fungi and oomycetes.

Oomycetes are plant pathogens that like fungi produce filamentous threads and obtain nutrients via absorption. Phytophthora capsici, P. infestans, Pythium ultimum and downy mildew pathogens are economically important groups of oomycete plant pathogens. P. infestans is the cause of late blight on tomatoes and potatoes and was the disease which precipitated the Irish potato famine. More recently, potato yield losses from this disease can reach as high as $6.7 billion annually. See, Nowicki M. et al., Potato and Tomato Late Blight Caused by Phytophthora infestans: An Overview of Pathology and Resistance Breeding, PLANT DIS. 2012 Jan, 96(1), 4-17. Downy mildew is a disease caused by several host-specialized oomycete species, including Pseudoperonospora cubensis (cucurbits), Bremia lactucae (leafy greens), and Plasmopara viticola (grapes). Like P. infestans, these downy mildew pathogens can quickly spread through agricultural fields and lead to devastating yield losses on crops which otherwise would comprise $7.5 billion annually in the United States alone. See, Crandall S. G., Advances in Diagnostics of Downy Mildews: Lessons Learned from Other Oomycetes and Future Challenges, PLANT DIS. 2018 Feb, 102(2), 265-275.

Fungal plant pathogens include over 20,000 species of fungi that are mostly from the phyla Ascomycota and Basidiomycota. Zymoseptoria tritici, known as Septoria leaf blotch, infects wheat plants. Septoria leaf blotch is a threat to wheat production worldwide. This infection is estimated to cost almost $300 million dollars per year in the United States and over $400 million dollars per year in Europe in lost crops. Efforts have been made to control Septoria leaf blotch but the disease has developed resistance to many fungicides.

Many synthetic fungicides have been developed to control plant diseases such as those described above. Despite this many plant pathogens have developed resistance to these synthetic fungicides and environmental and health concerns over the use of these chemical fungicides has driven the industry to search for safer alternatives such as naturally derived fungicides. Finally, whereas there are many biologically based fungicides which are registered for use against Botrytis, the number of products registered for use against oomycete pathogens is much more limited, due in part to the voracious nature of these pathogens.

Thus, there is a need in the art for naturally derived fungicides that controls oomycetes and a variety of fungal plant pathogens.

### SUMMARY OF THE INVENTION

In one aspect, the present invention is directed to methods of controlling a pest comprising applying an effective amount of one or more cervinomycins to the pest or an area in need of pest control, wherein the pest is a species of the Phylum Oomycota.

In another aspect, the present invention is further directed to methods of controlling a pest comprising applying an effective amount of one or more cervinomycins to the pest or an area in need of pest control, wherein the pest is a species of the Phylum Basidiomycota and preferably, wherein the one or more cervinomycins are selected from the group consisting of cervinomycin A1 and cervinomycin A2.

In another aspect, the present invention is further directed to methods of controlling a pest comprising applying an effective amount of one or more cervinomycins to the pest or an area in need of pest control, wherein the pest is a species of the Class Dothideomycetes and preferably, wherein the one or more cervinomycins are selected from the group consisting of cervinomycin A1 and cervinomycin A2.

In another aspect, the present invention is further directed to methods of controlling a pest comprising applying an effective amount of one or more cervinomycins to the pest or an area in need of pest control, wherein the pest is a species of the Class Leotiomycetes and preferably, wherein the one or more cervinomycins are selected from the group consisting of cervinomycin A1 and cervinomycin A2.

In another aspect, the present invention is directed to compositions for pest control comprising one or more cervinomycins and one or more excipients.

### DETAILED DESCRIPTION OF THE INVENTION

Applicant has unexpectedly discovered that cervinomycins are capable of controlling unwanted oomycete growth. Applicant has further unexpectedly discovered that particular cervinomycins are capable of controlling particular clades of fungi and not others.

In one embodiment, the present invention is directed to methods of controlling a pest comprising applying an effective amount of one or more cervinomycins to the pest or an area in need of pest control, wherein the pest is a species of the Phylum Oomycota, preferably of the Order Peronosporales or Pythiales, more preferably of the Families Peronosporaceae or Pythiaceae, even more preferably of the Genera Phytophthora, Bremia, Plasmopara, Pseudoperonospora, or Pythium, and most preferably of the species Pseudoperonospora cubensis, Bremia lactucae, Plasmopara viticola, Phytophthora infestans, Phytophthora capsici or Pythium ultimum. In another preferred embodiment, the species of Oomycota may also include Peronospora effusa and Peronospora destructor.

In another embodiment, the present invention is directed to methods of controlling a pest comprising applying an effective amount of one or more cervinomycins to the pest or an area in need of pest control, wherein the pest is a species of the Phylum Basidiomycota, preferably of the Class Ustilaginomycetes or Pucciniomycetes more preferably of the Order Ustilaginales or Pucciniales, even more preferably of the Families Ustilaginaceae, Pucciniaceae, or Phakopsoraceae, even more preferably of the Genera Ustilago, Phakopsora, or Puccinia, and most preferably of the species Ustilago maydis, Phakopsora pachyrhizi, or Puccinia triticina, preferably, wherein the one or more cervinomycins are selected from the group consisting of cervinomycin A1 and cervinomycin A2. In another preferred embodiment, the species of Basidiomycota may also include Rhizoctonia solani.

In another embodiment, the present invention is directed to methods of controlling a pest comprising applying an effective amount of one or more cervinomycins to the pest or an area in need of pest control, wherein the pest is a species of the Class Dothideomycetes, more preferably of the Orders Mycosphaerellales, Venturiales or Pleosporales, even more preferably of the Families Mycosphaerellaceae, Venturiaceae or Pleosporaceae, yet even more preferably of the Genera Zymoseptoria, Venturia, Cochliobolus, Pyrenophora, Alternaria or Cercospora and most preferably of the species Zymoseptoria tritici, Venturia carpophila, Cochliobolus miyabeanus, Pyrenophora teres, Alternaria solani, or Cercospora sojina and preferably, wherein the one or more cervinomycins are selected from the group consisting of cervinomycin A1 and cervinomycin A2.

In another embodiment, the present invention is directed to methods of controlling a pest comprising applying an effective amount of one or more cervinomycins to the pest or an area in need of pest control, wherein the pest is a species of the Class Leotimycetes, more preferably of the Order Helotiales, even more preferably the Family Sclerotiniaceae or Ploettnerulaceae and yet even more preferably of the Genus Rhynchosporium or Sclerotinia and most preferably of the species Rhynchosporium secalis or Sclerotinia sclerotiorum and preferably, wherein the one or more cervinomycins are selected from the group consisting of cervinomycin A1 and cervinomycin A2.

In another embodiment, the present invention is directed to methods of controlling a pest comprising applying an effective amount of one or more cervinomycins to the pest or an area in need of pest control, wherein the pest is a species of the Order Magnaporthales, more preferably of the Family Magnaporthaceae, even more preferably of the Genus Magnaporthe and most preferably of the species Magnaporthe oryzae and preferably, wherein the one or more cervinomycins are selected from the group consisting of cervinomycin A1 and cervinomycin A2.

In another embodiment, the present invention is directed to methods of controlling a pest comprising applying an effective amount of one or more cervinomycins to the pest or an area in need of pest control, wherein the pest is a species of the Order Amphisphaeriales, more preferably of the Family Sporocadaceae, even more preferably of the Genus Neopestalotiopsis, preferably, wherein the one or more cervinomycins are selected from the group consisting of cervinomycin A1 and cervinomycin A2.

In another embodiment, the present invention is directed to methods of controlling a pest comprising applying an effective amount of one or more cervinomycins to the pest or an area in need of pest control, wherein the pest is of the Genus Sclerotinia and most preferably of the species Sclerotinia sclerotiorum and preferably, wherein the one or more cervinomycins are selected from the group consisting of cervinomycin A1 and cervinomycin A2.

The one or more cervinomycins of the present invention may be applied at a concentration from about 0.01 to about 10,000 parts per million (“ppm”), preferably from about from about 0.01 to about 2,000. Further, the one or more cervinomycins of the present invention may be applied at a concentration from about 0.01 to about 5 ppm, more preferably from about 0.016 to about 5 ppm and even more preferably from about 0. to about 1 ppm and most preferably at about 0.016, 0.063, 0.1, 0.25, 0.5, 0.8, 1, or 5 ppm. Further, the one or more cervinomycins of the present invention may be applied at a concentration from about 0.01 to about 50 ppm, preferably from about 1 to about 60 ppm and even more preferably at about 3, 5, 6, 7.5, 12, 15, 30, 50, 60. Further, the one or more cervinomycins of the present invention may be applied at a concentration from about 50 to about 2000 ppm, preferably at about 200 ppm. Further, the one or more cervinomycins of the present invention may be applied at a concentration from about 120 to about 2,000 ppm, preferably at about 124, 192, 248, 370, 464, 491, 492, 495, 500, 981, 982, 984, 990, 1,000, 1,112, 1,200, 1,376, 1,962, 1,964, 1,968, or 2,000.

As used herein, the term cervinomycin refers to cervinomycins A1-A3, B1-B4, C1-C4 and salts and derivatives thereof. In a preferred embodiment, the one or more cervinomycins of the present invention are selected from the group consisting of cervinomycin A1 and cervinomycin A2.

As used herein, the term cervinomycin A1 refers to a compound listed under the CAS #82658-23-9 and having the following chemical structure:

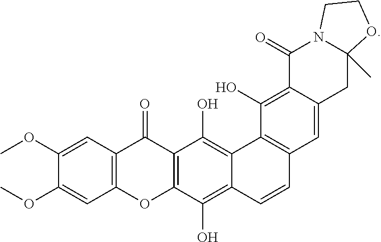 [SMILES: COc1cc2oc3c(O)c4ccc5cc6c(c(O)c5c4c(O)c3c(=O)c2cc1OC)C(=O)N1CCOC1(C)C6]

As used herein, the term cervinomycin A2 refers to a compound listed under the CAS #82658-22-8 and having the following chemical structure:

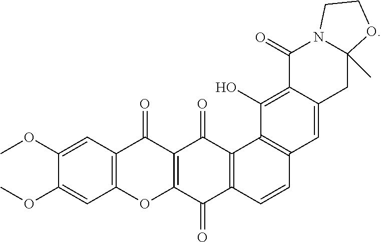 [SMILES: COc1cc2oc3c(c(=O)c2cc1OC)C(=O)c1c(ccc2cc4c(c(O)c12)C(=O)N1CCOC1(C)C4)C3=O]

The species Rhynchosporium secalis is a member of the genus Rhynchosporium of the Family Ploettnerulaceae of the Order Helotiales of the Class Leotiomycetes of the Phylum Ascomycota of the Kingdom Fungi.

The species Botrytis cinerea is a member of the genus Botrytis of the Family Sclerotiniaceae of the Order Helotiales of the Class Leotiomycetes of the Phylum Ascomycota of the Kingdom Fungi.

The species Sclerotinia sclerotiorum is a member of the genus Sclerotinia of the Family Sclerotiniaceae of the Order Helotiales of the Class Leotiomycetes of the Phylum Ascomycota of the Kingdom Fungi.

The species Podosphora xanthii is a member of the genus Podosphora of the Family Erysiphaceae of the Order Erysiphales of the Class Leotiomycetes of the Phylum Ascomycota of the Kingdom Fungi.

The species Erysiphe difusa is a member of the genus Erysiphe of the Family Erysiphaceae of the Order Erysiphales of the Class Leotiomycetes of the Phylum Ascomycota of the Kingdom Fungi.

The Genus Neopestalotiopsis is a member of the Family Sporocadaceae of the Order Amphisphaeriales of the Class Sordariomycetes of the Phylum Ascomycota of the Kingdom Fungi.

The species Magnaporthe oryzae is a member of the genus Magnaporthe of the Family Magnaporthaceae of the Order Magnaporthales of the Class Sordariomycetes of the Phylum Ascomycota of the Kingdom Fungi.

The species Fusarium graminearum is a member of the genus Fusarium of the Family Nectriaceae of the Order Hypocreales of the Class Sordariomycetes of the Phylum Ascomycota of the Kingdom Fungi. Fusarium graminearum is also known as Gibberella zeae.

The species Zymoseptoria tritici is a member of the genus Zymoseptoria of the Family Mycosphaerellaceae of the Order Mycosphaerellales of the Class Dothideomycetes of the Phylum Ascomycota of the Kingdom Fungi.

The species Venturia carpophila is a member of the genus Venturia of the Family Venturiaceae of the Order Venturiales of the Class Dothideomycetes of the Phylum Ascomycota of the Kingdom Fungi. The species Venturia carpophila is also known as Cladosporium carpophilum.

The species Cochliobolus miyabeanus is a member of the genus Cochliobolus of the Family Pleosporaceae of the Order Pleosporales of the Class Dothideomycetes of the Phylum Ascomycota of the Kingdom Fungi. The species Cochliobolus miyabeanus is also known as Bipolaris oryzae.

The species Pyrenophora teres is a member of the genus Pyrenophora of the Family Pleosporaceae of the Order Pleosporales of the Class Dothideomycetes of the Phylum Ascomycota of the Kingdom Fungi.

The species Alternaria solani is a member of the genus Alternaria of the Family Pleosporaceae of the Order Pleosporales of the Class Dothideomycetes of the Phylum Ascomycota of the Kingdom Fungi.

The species Cercospora sojina is a member of the genus Cercospora of the Family Mycosphaerellaceae of the Order Mycosphaerellales of the Class Dothideomycetes of the Phylum Ascomycota of the Kingdom Fungi.

The species Ustilago maydis is a member of the genus Ustilago of the Family Ustilaginaceae of the Order Ustilaginales of the Class Ustilaginomycetes of the Phylum Basidiomycota of the Kingdom Fungi.

The species Phakopsora pachyrhizi is a member of the genus Phakopsora of the Family Phakopsoraceae of the Order Pucciniales of the Class Pucciniomycetes of the Phylum Basidiomycota of the Kingdom Fungi.

The species Puccinia triticina is a member of the genus Puccinia of the Family Pucciniaceae of the Order Pucciniales of the Class Pucciniomycetes of the Phylum Basidiomycota of the Kingdom Fungi.

The species Rhizoctonia solani is a member of the genus Rhizoctonia of the Family Ceratobasidiaceae of the Order Cantharellales of the Class Agaricomycetes of the Phylum Basidiomycota of the Kingdom Fungi.

The species Phytophthora capsici is a member of the genus Phytophthora of the Family Peronosporaceae of the Order Peronosporales of the Phylum Oomycota.

The species Phytophthora infestans is a member of the genus Phytophthora of the Family Peronosporaceae of the Order Peronosporales of the Phylum Oomycota.

The species Pseudoperonospora cubensis is a member of the genus Phytophthora of the Family Peronosporaceae of the Order Peronosporales of the Phylum Oomycota.

The species Bremia lactucae is a member of the genus Phytophthora of the Family Peronosporaceae of the Order Peronosporales of the Phylum Oomycota.

The species Pythium ultimum is a member of the genus Pythium of the Family Pythiaceae of the Order Pythiales of the Phylum Oomycota. Pythium ultimum is also known as Globisporangium ultimum.

The species Plasmopara viticola is a member of the genus Plasmopara of the Family Peronosporaceae of the Order Peronosporales of the Phylum Oomycota.

The species Peronospora effusa is a member of the genus Peronospora of the Family Peronosporaceae of the Order Peronosporales of the Phylum Oomycota. Peronospora effusa is also known as Peronospora farinose f. sp. spinaciae.

The species Peronospora destructor is a member of the genus Peronospora of the Family Peronosporaceae of the Order Peronosporales of the Phylum Oomycota.

In another embodiment, the present invention is directed to a method of controlling a pest comprising applying a composition comprising one or more cervinomycins.

In another embodiment, the present invention is directed to compositions for pest control comprising one or more cervinomycins and one or more excipients.

In a preferred embodiment, compositions of the present invention may be directed to control any of the specific species or phylogenetic clades disclosed in this specification.

In a preferred embodiment, the compositions of the present invention may further comprise one or more excipients selected from the group consisting of solvents, anti-caking agents, stabilizers, defoamers, slip agents, humectants, dispersants, wetting agents, thickening agents, emulsifiers, penetrants, adjuvants, synergists, polymers, propellants and preservatives.

The compounds of the present invention can be applied by any convenient means. Those skilled in the art are familiar with the modes of application including but not limited to, spraying, brushing, soaking, granule application, pressurized liquids (aerosols), and fogging. Spraying includes space sprays. Space sprays include aerosols and thermal fog spray. Other modes of application familiar to those in the art include soil applications including spraying, drenching, drip lines, in-furrow treatments, or side-dressing and seed applications.

As used herein, “to control” a pest or “controlling” pest(s) refers to killing, inhibiting, incapacitating, repelling, or otherwise decreasing the negative impact of the pest on plants or animals to a level that is desirable to the grower, applicator or user.

As used herein, “an area in need of pest control” refers to any area that the pest is present during any life stage. One environment likely to be treated by the methods of the present invention includes the plants that the pest is living on and/or the surrounding soil. The pest's environment may also include an area where plants are grown, harvested, or in gardens, fields, greenhouses, or other buildings, and various indoor surfaces and structures, such as furniture including beds, and furnishings including books, clothing, etc.

As used herein, all numerical values relating to amounts, weight percentages and the like are defined as “about” or “approximately” each particular value, namely, plus or minus 10%. For example, the phrase “about 5,000 parts per million” is to be understood as “from 4,500 to 5,500 parts per million.” Therefore, amounts within 10% of the claimed values are encompassed by the scope of the claims.

As used herein, “composition” refers to one or more active ingredients in a carrier. The carrier may be a liquid, a semi-solid, a solid or a gas and may contain additional ingredients.

The term “effective amount” means the amount of the cervinomycin that will control the target pest. The “effective amount” will vary depending on the cervinomycin concentration, the type of pest(s) being treated, the severity of the pest infestation, the result desired, and the life stage of the pest during treatment, among other factors. Thus, it is not always possible to specify an exact “effective amount.” However, an appropriate “effective amount” in any individual case may be determined by one of ordinary skill in the art.

The articles “a,” “an” and “the” are intended to include the plural as well as the singular, unless the context clearly indicates otherwise. For example, the methods of the present invention are directed to controlling “pest”, but this can include control of a multiple pests (such as a more than one insect or more than one insect species or more than one mite or more than one mite species).

The disclosed embodiments are simply embodiments of the inventive concepts disclosed herein and should not be considered as limiting unless the claims expressly state otherwise.

The following examples are intended to illustrate the present invention and to teach one of ordinary skill in the art how to use the formulations of the invention. They are not intended to be limiting in any way.

### EXAMPLES

### Example 1. Controlling Particular Fungi with Cervinomycins In Vitro

### Method

Biological efficacy assays utilizing cervinomycins were conducted on Plasmospora viticola. Groups of grape plants were infected with P. viticola and treated with either 13, 50, 200 or 800 ppm of cervinomycin A1 or A2 or a killed TGAI containing 33.2% cervinomycin A1 and 66.7% cervinomycin A2. Treatments occurred at either 1 day before infection (“1 DBI”), 7 days before infection (“7 DBI”) or 1 day after infection (“1 DAI”). Percent control was based on the reduction of growth of a given pathogen on non-cervinomycin amended growth media in comparison to the growth observed on growth media amended with cervinomycin A1 and/or A2. Results can be found in Table 1, below.

TABLE 1

| | Dose | Plasmospora viticola | | |
|---|---|---|---|---|
| % control | (ppm) | 1DAI | 1DB1 | 7DBI |
| Cervinomycin | 13 | 0 | 100 | 80 |
| A1 | 50 | 0 | 100 | 99 |
| | 200 | 0 | 100 | 100 |
| | 800 | 7 | 100 | 100 |
| Cervinomycin | 13 | 0 | 96 | 61 |
| A2 | 50 | 3 | 100 | 91 |
| | 200 | 0 | 100 | 97 |
| | 800 | 5 | 100 | 100 |
| Killed TGAI* | 13 | 0 | 83 | 31 |
| | 50 | 3 | 96 | 87 |
| | 200 | 0 | 100 | 94 |
| | 800 | 0 | 100 | 100 |

*33.7% cervinomycin A1 and 66.3% cervinomycin A2

As seen in Table 1, above, treatment with 13-800 ppm cervinomycin A1 or A2 or a mixture thereof provided significant control of P. viticiola. This result is unexpected as there was no previous indication that cervinomycins would control P. viticiola.

### Example 2. Controlling Particular Fungi and Oomycetes with Cervinomycins In Vitro

### Method

Biological efficacy assays utilizing cervinomycins were conducted on Botrytis cinerea, Fusarium graminearum, Phytophthora capsici, Zymoseptoria tritici, Ustilago maydis, Rhynchosporium secalis, Pythium ultimum, Cladosporium carpophilum and Cochliobolus miyabeanus and were each separately applied in serial dilutions to determine percent control of each of the listed pests. Growth media with each of the listed pests were treated with either 1, 0.25, 0.063, 0.016 or 0.004 ppm of cervinomycin A1 or A2. Percent control was based on the reduction of growth of a given pathogen on non-cervinomycin amended growth media in comparison to the growth observed on growth media amended with cervinomycin A1 or A2. Results can be found in Table 2, below.

TABLE 2

| | % Control | | | | | |
|---|---|---|---|---|---|---|
| | Dose | Botrytis | Fusarium | Phytophthora | Zymoseptoria | Ustilago |
| | (ppm) | cinerea | graminearum | capsici | tritici | maydis |
| Cervinomycin | 1 | 99 | 31 | 100 | 73 | 100 |
| A1 | 0.25 | 92 | 20 | 90 | 7 | 94 |
| | 0.063 | 0 | 7 | 82 | 4 | 19 |
| | 0.016 | 0 | 6 | 13 | 0 | 11 |
| | 0.004 | 0 | 4 | 0 | 2 | 9 |
| Cervinomycin | 1 | 100 | 14 | 100 | 100 | 100 |
| A2 | 0.25 | 100 | 0 | 99 | 62 | 100 |
| | 0.063 | 70 | 9 | 90 | 6 | 90 |
| | 0.016 | 2 | 4 | 75 | 2 | 12 |
| | 0.004 | 3 | 8 | 4 | 1 | 6 |

| | % Control | | | | |
|---|---|---|---|---|---|
| | Dose | Rhynchosporium | Pythium | Cladosporium | Cochliobolus |
| | (ppm) | secalis | ultimum | carpophilum | miyabeanus |
| Cervinomycin | 1 | 98 | 98 | 98 | 74 |
| A1 | 0.25 | 98 | 97 | 63 | 59 |
| | 0.063 | 79 | 18 | 16 | 29 |
| | 0.016 | 0 | 8 | 0 | 2 |
| | 0.004 | 6 | 0 | 9 | 1 |
| Cervinomycin | 1 | 100 | 99 | 99 | 87 |
| A2 | 0.25 | 99 | 96 | 99 | 73 |
| | 0.063 | 98 | 99 | 46 | 49 |
| | 0.016 | 71 | 13 | 0 | 20 |
| | 0.004 | 21 | 0 | 0 | 0 |

### Results

As demonstrated in Table 2, each of cervinomycin A1 and cervinomycin A2 provided significant control of various pests in vitro. Specifically, cervinomycin A1 and A2 provided at least 70% control of species of the Phyla Oomycota and Basidiomycota and the phylogenetic Classes Leotiomycetes and Dothideomycetes. However, application of cervinomycin A1 or A2 provided no more than 31% control of a species of the phylogenetic Class Sordariomycetes.

### Example 3. Controlling Particular Fungi and Oomycetes with Cervinomycins In Vivo

### Method

Biological efficacy assays utilizing cervinomycins were conducted on Pseudoperonospora cubensis and Botrytis cinerea. Plants were treated via foliar application with either 1, 3, 6, 7.5, 12, 15, 25, 30 50 or 192 ppm of cervinomycin A1 or A2 as indicated in Table 3, below. Once plants had dried they were inoculated with the pathogen, then were stored in a controlled climate chamber under high humidity for 4-6 days. At the end of the experiment disease severity was determined based on the percentage of plant tissue that was visually symptomatic. Percent control was based on the reduction of symptoms from plants treated with cervinomycin A1 or A2 compared to plants that were treated with a carrier control. Results can be found in Table 3, below.

TABLE 3

| | | P. cubensis | | | | | | | |
|---|---|---|---|---|---|---|---|---|---|
| | Dose | Jul. 14, | Jul. 21, | Jul. 28, | Oct. 20, | | Oct. 27, | | |
| Compound | (ppm) | 2020 | 2020 | 2020 | 2020 | | 2020 | B. cinerea | |
| Carrier Control | 0 | 98 | 100 | 67 | 70 | | 79 | 63.3 | |
| Cervinomycin | 1 | — | — | — | 13 | (81%)* | 2 (98%) | 31 | (51%) |
| A1 | 3 | — | — | 47 (30%) | 3 | (96%) | 1 (99%) | 17 | (74%) |
| | 6 | — | — | — | 2 | (97%) | 1 (99%) | 9 | (85%) |
| | 7.5 | — | — | 43 (36%) | — | | — | — | |
| | 12 | — | — | — | 1 | (99%) | 2 (98%) | 2 | (96%) |
| | 15 | — | — | 16 (76%) | — | | — | — | |
| | 25 | — | — | — | 1 | (99%) | 1 (99%) | 2 | (96%) |
| | 30 | 25 (74%) | 3 (97%) | 7 (89%) | — | | — | — | |
| | 50 | — | — | — | 0.4 | (99%) | 1 (99%) | 1 | (98%) |
| | 192 | — | 3 (97%) | — | — | | — | — | |
| Cervinomycin | 1 | — | — | — | 52 | (26%) | 7 (91%) | 58 | (9%) |
| A2 | 3 | — | — | — | 27 | (61%) | 7 (91%) | 45 | (29%) |
| | 6 | — | — | — | 16 | (77%) | 2 (98%) | 45 | (29%) |
| | 12 | — | — | — | 3 | (95%) | 1 (99%) | 30 | (53%) |
| | 15 | — | — | 28 (58%) | — | | — | — | |
| | 25 | — | — | — | 4 | (94%) | 1 (99%) | 24 | (63%) |
| | 30 | 73 (26%) | — | 10 (85%) | — | | — | — | |
| | 50 | — | — | — | 7 | (89%) | 2 (98%) | 9 | (87%) |

| | | | | | | |
|---|---|---|---|---|---|---|
| 60 | — | — | 18 (73%) | — | — | — |

*Disease severity (percent control)

As demonstrated in Table 3, above, cervinomycin A1 and A2 provided significant control of each of Pseudoperonospora cubensis and Botrytis cinerea. This result is unexpected as there was no previous indication that cervinomycins would control oomycetes or that each of A1 and A2 would control Botrytis cinerea.

### Example 4. Controlling Particular Fungi and Oomycetes with Cervinomycins In Vivo

### Method

Biological efficacy assays utilizing cervinomycins were conducted on Magnaporthe oryzae, Puccinia tritici, Pyrenophora teres, Phakospora pachyrhizi, Phytophthora infectans, Psuedoperonospora cubensis, Sclerotinia sclerotiorum, Podosphaera xanthii, Erysiphe diffusa, Alternaria solani, and Cercospora sojina. Host plants used were rice, wheat, barley, soybean, tomato, cucumber, and common bean. Plants were treated with either 11.3, 45 or ppm of cervinomycin A1 or A2 or Killed TGAI at 5.5, 22 or 88 ppm total cervinomycin wherein 33.7% was cervinomycin A1 and 66.3% was cervinomycin A2 as indicated in Table 4, below wherein DBI denotes “days before inoculation with the pest” and DAI denotes “days after inoculation with the pest”. Disease severity was determined using known methods in the field. Percent control was based on the reduction of growth of a given pathogen on plants treated with cervinomycin A1 and/or A2 compared to plants that were non-treated. Results can be found in Table 4, below.

TABLE 4

| | | Magnaporthe | Puccinia | Zymoseptoria | | Pyrenophora | Phakopsora | | Phytophthora |
|---|---|---|---|---|---|---|---|---|---|
| | | oryzae | triticina | tritici | | teres | pachyrhizi | | infestans |
| | Dose | Rice | Wheat | Wheat | | Barley | Soybean | | Tomato |
| | (ppm) | 1DBI | 6DBI | 3DAI | 4DBI | 1DBI | 3DAI | 4DBI | 1DBI |
| Cervinomycin | 180 | 0 | 3 | 0 | 0 | 0 | 0 | 3 | 3 |
| A1 | 45 | 0 | 0 | 0 | 0 | 0 | 0 | 1 | 0 |
| | 11.3 | 0 | 0 | 0 | 0 | 0 | 0 | 0 | 0 |
| Cervinomycin | 180 | 0 | 0 | 0 | 0 | 0 | 0 | 2 | 3 |
| A2 | 45 | 0 | 0 | 0 | 0 | 0 | 0 | 0 | 0 |
| | 11.3 | 0 | 0 | 0 | 0 | 0 | 0 | 0 | 0 |
| Killed TGAI | 88 | 0 | 0 | 0 | 0 | 3 | 0 | 5 | 4 |
| (Killed and | | | | | | | | | |
| Concentrated | 22 | 0 | 0 | 0 | 0 | 0 | 0 | 4 | 3 |
| Beer)* | | | | | | | | | |
| Suspension | 5.5 | 0 | 0 | 0 | 0 | 0 | 0 | 1 | 0 |
| Concentrate | | | | | | | | | |
| Killed TGAI | 88 | 4 | 0 | 0 | 0 | 3 | 0 | 5 | 3 |
| (Killed and | | | | | | | | | |
| Concentrated | 22 | 0 | 0 | 0 | 0 | 0 | 0 | 2 | 3 |
| Beer)* | | | | | | | | | |
| in water | 5.5 | 0 | 0 | 0 | 0 | 0 | 0 | 0 | 0 |
| Killed TGAI | 200 | 0 | 5 | 0 | 0 | 5 | 0 | 4 | 4 |
| (Killed and | 50 | 0 | 3 | 0 | 0 | 3 | 0 | 3 | 4 |
| Concentrated | 12.5 | 0 | 0 | 0 | 0 | 0 | 0 | 1 | 4 |
| Beer)* | | | | | | | | | |
| Suspension | | | | | | | | | |
| Concentrate | | | | | | | | | |
| Killed TGAI | 200 | 3 | 3 | 0 | 0 | 4 | 0 | 4 | 4 |
| (Killed and | 50 | 0 | 0 | 0 | 0 | 3 | 0 | 3 | 4 |
| Concentrated | 12.5 | 0 | 0 | 0 | 0 | 0 | 0 | 2 | 3 |
| Beer)* in water | | | | | | | | | |

| | | | Sclerotinia | | | | |
|---|---|---|---|---|---|---|---|
| | | Pseudoperonospora | sclerotiorum | Podosphaera | Erysiphe | Alternaria | Cercospora |
| | | cubensis | Common | xanthii | diffusa | solani | sojina |
| | Dose | Cucumber | bean | Cucumber | Soybean | Tomato | Soybean |
| | (ppm) | 1DBI | 1DBI | 1DBI | 2DAI | 1DBI | 1DBI |
| Cervinomycin | 180 | 4 | 5 | 0 | 0 | 3 | / |
| A1 | 45 | 0 | 2 | 0 | 0 | 0 | / |
| | 11.3 | 0 | 0 | 0 | 0 | 0 | / |
| Cervinomycin | 180 | 3 | 0 | 0 | 0 | 0 | / |
| A2 | 45 | 0 | 0 | 0 | 0 | 0 | / |
| | 11.3 | 0 | 0 | 0 | 0 | 0 | / |
| Killed TGAI | 88 | 5 | 5 | 0 | 0 | 3 | / |
| (Killed and | | | | | | | |
| Concentrated | 22 | 4 | 3 | 0 | 0 | 0 | / |
| Beer)* | | | | | | | |
| Suspension | 5.5 | 1 | 0 | 0 | 0 | 0 | / |
| Concentrate | | | | | | | |
| Killed TGAI | 88 | 4 | 5 | 0 | 0 | 3 | 3 |
| (Killed and | | | | | | | |
| Concentrated | 22 | 2 | 0 | 0 | 0 | 2 | 0 |
| Beer)* | | | | | | | |
| in water | 5.5 | 0 | 0 | 0 | 0 | 0 | 0 |
| Killed TGAI | 200 | 5 | 5 | 0 | 0 | 5 | 4 |
| (Killed and | 50 | 5 | 5 | 0 | 0 | 4 | 3 |
| Concentrated | 12.5 | 3 | 3 | 0 | 0 | 4 | 0 |
| Beer)* | | | | | | | |
| Suspension | | | | | | | |
| Concentrate | | | | | | | |
| Killed TGAI | 200 | 5 | 5 | 0 | 0 | 5 | 4 |
| (Killed and | | | | | | | |
| Concentrated | 50 | 3 | 5 | 0 | 0 | 5 | 2 |
| Beer)* | | | | | | | |
| in water | 12.5 | 1 | 3 | 0 | 0 | 3 | 0 |

% control: 5 (about 100%); 4 (about 90%), 3 (about 70%); 2 (about 50%); 1 (about 25%); 0 (about 0%)
*33.7% cervinomycin A1 and 66.3% cervinomycin A2

As seen in Table 4, above, application of cervinomycins provide significant control of Magnaporthe oryzae, Puccinia tritici, Pyrenophora teres, Phakospora pachyrhizi, Phytophthora infectans, Psuedoperonospora cubensis, Sclerotinia sclerotiorum, Alternaria solani, and Cercospora sojina. However, application of cervinomycins did not provide significant control of Erysiphe diffusa or Podosphaera xanthii. This result is unexpected as control of there was no previous indication that cervinomycins would control some but not all fungi and there was no previous indication that cervinomycins would control oomycetes.

### Example 5. Controlling Particular Fungi and Oomycetes with Cervinomycins on Live Plants

### Method

Field and greenhouse trials using cervinomycins were conducted with Phytophthora infestans, Pseudoperonospora cubensis, Phytophthora capsici, Bremia lactucae, Botrytis cinerea, Podosphora xanthii, Alternaria solani, and Neopestalotiopsis sp. Host plants used included potato, cucumber, squash, lettuce, pepper and strawberry as indicated in Table 5, below. Plants were either left untreated or were treated with cervinomycins as indicted in Table 5, below. Applications were initiated prior to initial pathogen infection, typically within 7 days pre-infection, and then continued every 5-7 days through the duration of the trial. Host plants were scored weekly for disease severity (% of plant tissue showing symptoms). Results from a representative assessment date can be seen in Table 5, below.

TABLE 5

| | | | | | Disease |
|---|---|---|---|---|---|
| | | | | | Severity |
| | | Dose | | Disease | % |
| Pest | Plant | (ppm) | | Severity | Control |
| P. infestans | Potato | 0 | | 49 | 0 |
| P. infestans | Potato | 513.7 | A1 | 10 | 80 |
| | | 686.3 | A2 | | |
| P. infestans | Potato | 32.8 | A1 | 40 | 19 |
| | | 90.8 | A2 | | |
| P. infestans | Potato | 98.2 | A1 | 15 | 70 |
| | | 271.9 | A2 | | |
| P. infestans | Potato | 295.3 | A1 | 9 | 83 |
| | | 817.1 | A2 | | |
| P. infestans | Potato | 0 | | 100 | 0 |
| P. infestans | Potato | 640.6 | A1 | 49 | 51 |
| | | 735.4 | A2 | | |
| P. infestans | Potato | 129.2 | A1 | 47 | 53 |
| | | 334.8 | A2 | | |
| P. infestans | Potato | 0 | | 54 | 0 |
| P. infestans | Potato | 281.2 | A1 | 17 | 68 |
| | | 210.9 | A2 | | |
| P. infestans | Potato | 562.4 | A1 | 15 | 72 |
| | | 421.8 | A2 | | |
| P. infestans | Potato | 1124.8 | A1 | 9 | 83 |
| | | 843.6 | A2 | | |
| P. infestans | Potato | 0 | | 63 | 0 |
| P. infestans | Potato | 143.7 | A1 | 70 | −12 |
| | | 356.7 | A2 | | |
| P. infestans | Potato | 287.5 | A1 | 70 | −12 |
| | | 713.4 | A2 | | |
| P. infestans | Potato | 575 | A1 | 61 | 2 |
| | | 1426.8 | A2 | | |
| P. cubensis | Cucumber | 0 | | 52 | 0 |
| P. cubensis | Cucumber | 513.7 | A1 | 33 | 37 |
| | | 686.3 | A2 | | |
| P. cubensis | Cucumber | 32.8 | A1 | 42 | 19 |
| | | 90.8 | A2 | | |
| P. cubensis | Cucumber | 98.2 | A1 | 38 | 28 |
| | | 271.9 | A2 | | |
| P. cubensis | Cucumber | 295.3 | A1 | 39 | 26 |
| | | 817.1 | A2 | | |
| P. cubensis | Squash | 0 | | 41 | 0 |
| P. cubensis | Squash | 513.7 | A1 | 14 | 66 |
| | | 686.3 | A2 | | |
| P. cubensis | Squash | 32.8 | A1 | 24 | 42 |
| | | 90.8 | A2 | | |
| P. cubensis | Squash | 98.2 | A1 | 22 | 46 |
| | | 271.9 | A2 | | |
| P. cubensis | Squash | 295.3 | A1 | 18 | 56 |
| | | 817.1 | A2 | | |
| P. cubensis | Cucumber | 0 | | 34 | 0 |
| P. cubensis | Cucumber | 500 | A2 | 25 | 27 |
| P. cubensis | Cucumber | 1000 | A2 | 26 | 22 |
| P. cubensis | Cucumber | 1500 | A2 | 19 | 44 |
| P. cubensis | Cucumber | 0 | | 4.9 | 0 |
| P. cubensis | Cucumber | 143.6 | A1 | 2.9 | 41 |
| | | 356.4 | A2 | | |
| P. cubensis | Cucumber | 287.2 | A1 | 1.8 | 63 |
| | | 712.8 | A2 | | |
| P. cubensis | Cucumber | 574.5 | A1 | 0.5 | 90 |
| | | 1425.5 | A2 | | |
| B. lactucae | Lettuce | 0 | | 47 | 0 |
| B. lactucae | Lettuce | 513.7 | A1 | 19 | 60 |
| | | 686.3 | A2 | | |
| B. lactucae | Lettuce | 32.8 | A1 | 25 | 46 |
| | | 90.8 | A2 | | |
| B. lactucae | Lettuce | 98.2 | A1 | 19 | 60 |
| | | 271.9 | A2 | | |
| B. lactucae | Lettuce | 295.3 | A1 | 9 | 81 |
| | | 817.1 | A2 | | |
| B. lactucae | Lettuce | 0 | | 13.3 | 0 |
| B. lactucae | Lettuce | 143.6 | A1 | 6.6 | 50 |
| | | 356.4 | A2 | | |
| B. lactucae | Lettuce | 287.2 | A1 | 9.6 | 28 |
| | | 712.8 | A2 | | |
| B. lactucae | Lettuce | 574.5 | A1 | 5.5 | 59 |
| | | 1425.5 | A2 | | |
| B. cinerea | Pepper | 0 | | 56 | 0 |
| B. cinerea | Pepper | 216.5 | A1 | 39 | 29 |
| | | 283.5 | A2 | | |
| P. xanthii | Squash | 0 | | 49 | 0 |
| P. xanthii | Squash | 513.7 | A1 | 64 | −31 |
| | | 686.3 | A2 | | |
| P. xanthii | Squash | 32.8 | A1 | 59 | −21 |
| | | 90.8 | A2 | | |
| P. xanthii | Squash | 98.2 | A1 | 60 | −23 |
| | | 271.9 | A2 | | |
| P. xanthii | Squash | 295.3 | A1 | 57 | −16 |
| | | 817.1 | A2 | | |
| A. solani | Potato | 0 | | 33 | 0 |
| A. solani | Potato | 280.5 | A1 | 28 | 15 |
| | | 210.4 | A2 | | |
| A. solani | Potato | 561 | A1 | 20 | 38 |
| | | 420.8 | A2 | | |
| A. solani | Potato | 1122 | A1 | 10 | 69 |
| | | 841.5 | A2 | | |
| A. solani | Potato | 0 | | 21 | 0 |
| A. solani | Potato | 281.2 | A1 | 9 | 55 |
| | | 210.9 | A2 | | |
| A. solani | Potato | 562.4 | A1 | 6 | 72 |
| | | 421.8 | A2 | | |
| A. solani | Potato | 1124.8 | A1 | 6 | 70 |
| | | 843.6 | A2 | | |
| P. capsici | Pepper | 0 | | 6 | 0 |
| P. capsici | Pepper | 140.9 | A1 | 4 | 35 |
| | | 349.6 | A2 | | |
| P. capsici | Pepper | 281.8 | A1 | 4 | 43 |
| | | 699.3 | A2 | | |
| P. capsici | Pepper | 563.6 | A1 | 5 | 22 |
| | | 1398.5 | A2 | | |
| P. capsici | Pepper | 0 | | 66 | 0 |
| P. capsici | Pepper | 141.4 | A1 | 41 | 38 |
| | | 106.1 | A2 | | |
| P. capsici | Pepper | 282.9 | A1 | 21 | 69 |
| | | 212.1 | A2 | | |
| P. capsici | Pepper | 565.7 | A1 | 27 | 59 |
| | | 424.3 | A2 | | |
| P. capsici | Pepper | 0 | | 9 | 0 |
| P. capsici | Pepper | 140.9 | A1 | 7 | 24 |
| | | 349.6 | A2 | | |
| P. capsici | Pepper | 281.8 | A1 | 9 | 2 |
| | | 699.3 | A2 | | |
| P. capsici | Pepper | 563.6 | A1 | 9 | 5 |
| | | 1398.5 | A2 | | |
| Neopestalotiopsis sp. | Strawberry | 0 | | 28 | 0 |
| Neopestalotiopsis sp. | Strawberry | 143.6 | A1 | 7 | 77 |
| | | 356.4 | A2 | | |

As demonstrate in Table 5, above, application of cervinomycins provided significant control of Phytophthora infestans, Pseudoperonospora cubensis, Phytophthora capsici, Bremia lactucae, Botrytis cinerea, Alternaria solani, and Neopestalotiopsis sp. However, application of cervinomycins did not provide significant control of Podosphora xanthii. This result is unexpected as control of there was no previous indication that cervinomycins would control some but not all fungi and there was no previous indication that cervinomycins would control oomycetes.

What is claimed is:

1. A method of controlling a pest comprising applying an effective amount of one or more cervinomycins to the pest or an area in need of pest control, wherein the pest is a species of the Phylum Oomycota.

2. The method of claim 1, wherein the pest is a species of the Order Peronosporales or Pythiales.

3. The method of claim 2, wherein the pest is selected from the group consisting of Pseudoperonospora cubensis, Bremia lactucae, Plasmopara viticola, Phytophthora infestans, Phytophthora capsici and Pythium ultimum.

4. The method of claim 1, wherein the one or more cervinomycins is selected from cervinomycin A1 and cervinomycin A2.

5. A method of controlling a pest comprising applying an effective amount of one or more cervinomycins to the pest or an area in need of pest control, wherein the pest is a species of the Phylum Basidiomycota.

6. The method of claim 5, wherein the pest is a species of the Class Ustilaginomycetes or Pucciniomycetes.

7. The method of claim 6, wherein the pest is selected from the group consisting of Ustilago maydis, Phakopsora pachyrhizi, or Puccinia triticina.

8. The method of claim 5, wherein the one or more cervinomycins is selected from cervinomycin A1 and cervinomycin A2.

9. A method of controlling a pest comprising applying an effective amount of one or more cervinomycins to the pest or an area in need of pest control, wherein the pest is a species of the Class Dothideomycetes.

10. The method of claim 9, wherein the pest is a species of an Order selected from a group consisting of Mycosphaerellales, Venturiales or Pleosporales.

11. The method of claim 10, wherein the pest is selected from the group consisting of Zymoseptoria tritici, Venturia carpophila, Cochliobolus miyabeanus, Pyrenophora teres, Alternaria solani, and Cercospora sojina.

12. The method of claim 9, wherein the one or more cervinomycins is selected from cervinomycin A1 and cervinomycin A2.

13. A method of controlling a pest comprising applying an effective amount of one or more cervinomycins to the pest or an area in need of pest control, wherein the pest is a species of the Class Leotiomycetes.

14. The method of claim 13, wherein the pest is a species of the Family Ploettnerulaceae or Sclerotiniaceae.

15. The method of claim 14, wherein the pest is Rhynchosporium secalis or Sclerotinia sclerotiorum.

16. The method of claim 13, wherein the one or more cervinomycins is selected from cervinomycin A1 and cervinomycin A2.

17. A method of controlling a pest comprising applying an effective amount of one or more cervinomycins to the pest or an area in need of pest control, wherein the pest is a species of the Order Magnaporthales.

18. The method of claim 17, wherein the pest is of the species Magnaporthe oryzae.

19. A method of controlling a pest comprising applying an effective amount of one or more cervinomycins to the pest or an area in need of pest control, wherein the pest is a species of the Order Amphisphaeriales.

20. The method of claim 19, wherein the pest is a species of the Genus Neopestalotiopsis.
